(19) United States
(12) Patent Application Publication
(10) Pub. No.: US 2016/0041603 A1
(43) Pub. Date: Feb. 11, 2016

(54) Power Management Apparatus, Systems, and Methods for Increased Power Loads

(71) Applicant: New Concepts Development Corp., Woodstock, IL (US)

(72) Inventor: Lawrence O'Connor, Austin, TX (US)

(21) Appl. No.: 14/800,945

(22) Filed: Jul. 16, 2015

Related U.S. Application Data
(60) Provisional application No. 62/025,252, filed on Jul. 16, 2014.

(51) Int. Cl. G06F 1/32; G06F 13/42; G06F 1/26

(52) U.S. Cl. CPC G06F 1/3287; G06F 1/266; G06F 13/426

(57) ABSTRACT

The present invention relates to powering electronic peripheral devices. Specifically, the present invention relates to switching, combining, and/or partially using two or more power sources to efficiently and fully power peripheral devices, especially devices with peak power demands higher than the power available from a common power source. More specifically, the present invention relates to drawing power from an interface, such as USB, Thunderbolt™, FireWire, partially storing power in a location, and utilizing the stored power to reach peak power demands higher than the power available from the interface.

The present invention claims priority to U.S. Provisional Pat. App. No. 62/025,252, titled “Power Management Apparatus, Systems, and Methods for Increased Power Loads,” filed Jul. 16, 2014, which is expressly incorporated herein by reference in its entirety.

### TECHNICAL FIELD

The present invention relates to powering electronic peripheral devices. Specifically, the present invention relates to switching, combining, and/or partially using two or more power sources to efficiently and fully power peripheral devices, especially devices with peak power demands higher than the power available from a common power source. More specifically, the present invention relates to drawing power from an interface, such as USB, Thunderbolt™, FireWire, partially storing power in a location, and utilizing the stored power to reach peak power demands higher than the power available from the interface.

### BACKGROUND

It is, of course, generally known to power electronic devices. Power, measured in watts, is voltage (measured in volts) multiplied by current (measured in amps). Electronic devices are usually powered with one power cable that may or may not have an alternating current to direct current (“AC/DC”) converter, typically because delivery of electrical power to homes and business is done via AC current. AC/DC converters generally have a transformer to adjust a power source's voltage to an acceptable level, a rectifier to convert the alternating current into a pulsing direct current, and a filter to convert the pulse into a direct current. These converters are generally device-specific because different devices require different operating voltage and current levels.

AC/DC converters are usually included with an electronic device when it is purchased. With so many different electronic devices available, there exists an overabundance of external power sources. A need, therefore, exists for apparatuses, systems, and methods for powering electronic devices that either eliminate the need for external power sources or reduce the size of said external power sources.

Frequently, similar devices use similar voltage and/or current levels. When such devices fit into an industry standard, different types of external power sources are unnecessary. Additionally, universal AC/DC converters replace the need for multiple different external power sources. Moreover, a need exists for apparatuses, systems, and methods for universally powering electronic devices.

Often, devices are powered by computer interfaces, such as the Universal Serial Bus (“USB”). USB has had many generations including USB 1.0, 2.0, and 3.0. USB 2.0 is the most common and generally supplies 4.75 volts to 5.25 volts and up to 500 milliamps to a device. USB 3.0 generally supplies 4.45 volts to 5.25 volts and up to 900 milliamps. Computer port powering generally eliminates the need for external power sources for certain low power consuming devices. Likewise, a need exists for apparatuses, systems, and methods for powering electronic devices that require more power than a standard computer interface can provide.

Commonly, electronic devices improve in efficiency and functionality over time. In many cases, improved electronic devices require more voltage and/or more current than previous generations of electronic devices. High-speed external disk drives, for example, require higher voltage and/or current levels than can be provided by a single computer port. Recently, Y-cables, having two USB connectors on a single end to draw power from two USB ports, have been used to obtain higher voltage and/or current. This requires the additional Y-cable to be produced, sold, and purchased by a consumer. Similarly, a need exists for apparatus, systems, and methods for powering electronic devices using standard cables.

Usually, increases in required voltage and/or current levels lead to new interfaces capable of handling such increases. The Thunderbolt™ interface was recently created to provide a maximum of 18 volts and 550 milliamps. While a Thunderbolt™ port can produce high voltage, it is still limited in current (amps). Some devices presently need, and further devices will need, more current that can be provided solely through a Thunderbolt™ port. Additionally, a need exists for apparatuses, systems, and methods for powering electronic devices that require more power than a Thunderbolt™ port can provide.

Often, devices have different interface connections for drawing power. Some devices are powered via USB, some are powered by FireWire, some are powered by Thunderbolt™, and some are powered by alternate interfaces. A need exists for apparatuses, systems, and methods that can be adapted to a plurality of interfaces.

Frequently, power management systems are external components that are connected between a computer interface and the device being managed. This requires having the external component along with any additional cables for connecting the external component to the computer interface or to the device being managed. A need exists for apparatuses, systems, and methods that can be incorporated within a device.

### SUMMARY OF THE INVENTION

The present invention relates to powering electronic peripheral devices. Specifically, the present invention relates to switching, combining, and/or partially using two or more power sources to efficiently and fully power peripheral devices, especially devices with peak power demands higher than the power available from a common power source. More specifically, the present invention relates to drawing power from an interface, such as USB, Thunderbolt™, FireWire, partially storing power in a location, and utilizing the stored power to reach peak power demands higher than the power available from the interface.

To this end, in an embodiment of the present invention, a power management apparatus is provided. The power management apparatus comprises an interface input for connecting the power management apparatus to a computer interface, a power storage component, and a controller that manages power from the interface input and the power storage component.

To this end, in an embodiment of the present invention, a power management system is provided. The power management system comprises a peripheral device, and a power management system disposed within the peripheral device, wherein the power management system comprises an interface input for connecting the power management apparatus to a computer interface, a power storage component, and a controller that manages power from the interface input and the power storage component.

To this end, in an embodiment of the present invention, a power management method is provided. The power management method comprises the steps of diverting power from an interface input having a first power level to a power storage component, directing power from the interface input to a controller, drawing power from the power storage component to the controller, and creating a second power level higher than the first power level from the controller.

It is, therefore, an advantage and objective of the present invention to provide apparatuses, systems, and methods for powering electronic devices that either eliminate the need for external power sources or reduce the size of said external power sources.

It is an advantage and objective of the present invention to provide apparatuses, systems, and methods for universally powering electronic devices.

It is an advantage and objective of the present invention to provide apparatuses, systems, and methods for powering electronic devices that require more power than a standard computer interface can provide.

It is an advantage and objective of the present invention to provide apparatus, systems, and methods for powering electronic devices using standard cables.

It is an advantage and objective of the present invention to provide apparatuses, systems, and methods for powering electronic devices that require more power than a Thunderbolt™ port can provide.

It is an advantage and objective of the present invention to provide apparatuses, systems, and methods that can be adapted to a plurality of interfaces.

It is an advantage and objective of the present invention to provide apparatuses, systems, and methods that can be incorporated within a device.

Additional features and advantages of the present invention are described in, and will be apparent from, the detailed description of the presently preferred embodiments and from the drawings.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 illustrates a diagram of a power management apparatus in an embodiment of the present invention.

### DETAILED DESCRIPTION OF THE PRESENTLY PREFERRED EMBODIMENTS

The present invention relates to powering electronic peripheral devices. Specifically, the present invention relates to switching, combining, and/or partially using two or more power sources to efficiently and fully power peripheral devices, especially devices with peak power demands higher than the power available from a common power source. More specifically, the present invention relates to drawing power from an interface, such as USB, Thunderbolt™, FireWire, partially storing power in a location, and utilizing the stored power to reach peak power demands higher than the power available from the interface.

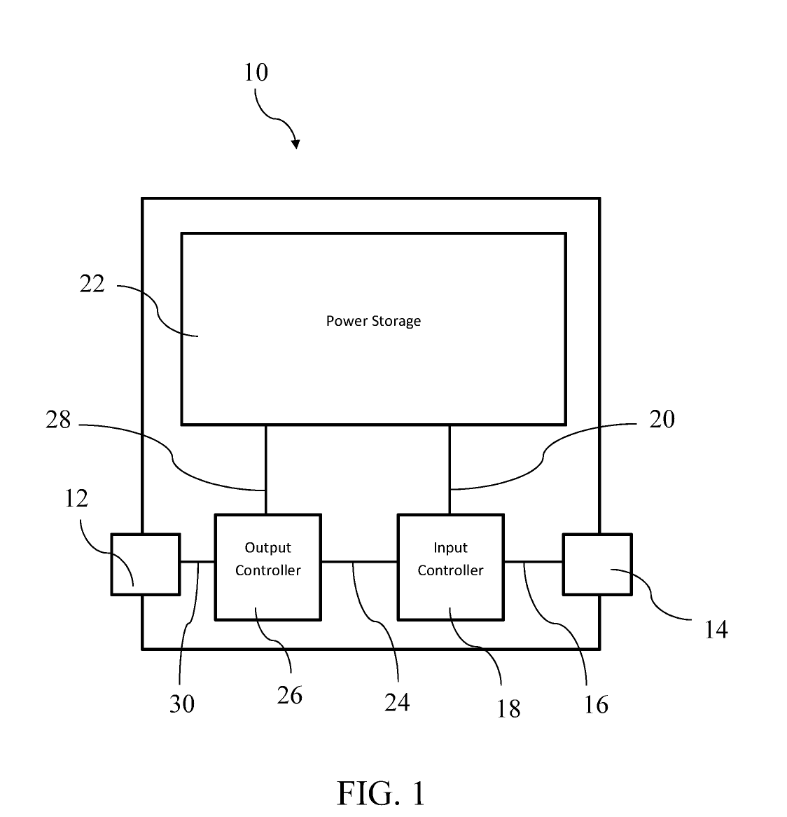

Now referring to the figures, wherein like numerals refer to like parts, FIG. 1 illustrates a power management apparatus 10. The power management apparatus 10 may be an external device connectable to a peripheral device on a first end 12 and a computer interface on a second end 14. In a preferred embodiment, the power management apparatus 10 may be implemented directly within a peripheral device, such that the power management apparatus 10 may be internally connected to the peripheral device on the first end 12 and externally connectable to the computer interface on the second end 14.

As shown in FIG. 1, the second end 14 may be connected to a first bus 16. The first bus 16 may be connected to an input controller 18. A second bus 20 may be connected to the input controller 18 on one end and connected to a power storage component 22 on another end. Specifically, resources such as power, voltage, current, and/or data may flow through the first bus 16, the input controller 18, and the second bus 20 into the power storage component 22. Additionally, a third bus 24 may exit the input controller 18 and enter an output controller 26. A fourth bus 28 may exit the power storage component 22 and enter the output controller 26. The output controller 26 may then output resources such as power, voltage, current, and/or data on a fifth bus 30, which may exit on the first end 12.

The power storage component 22 may be connected in parallel to the input controller 18, the third bus 24, and the output controller 26 such that the voltage drop across the power storage component 22 and the combination of the input controller 18, the third bus 24, and the output controller 26 are the same. The power storage component 22 may be made up of a plurality capacitors, super capacitors, batteries, other power holding technologies known to one skilled in the art, or any combination thereof. Additional power storage components (capacitors, super capacitors, batteries, etc.) may be added as necessary both prior to manufacture or after manufacture in order to accommodate different resource needs. The power storage component 22 may charge over time as power, including voltage and current, flows into the power storage component 22 from the second bus 20 as determined by the input controller 18. Additionally, the power storage component 22 may subsequently allow power, including voltage and current, to flow outwardly along the fourth bus 28 as determined by the output controller 26.

As stated above, a computer interface may connect to the power management apparatus on the second end 14. Of course, another interface may be connected and the present invention is not limited as such. The computer interface, or other interface, may provide resources, including power, voltage, current, and/or data to the power management device 10 through the first end 14 and the first bus 16.

The input controller 18 may communicate with the power storage component 22 and may determine whether the power storage component 22 is fully charged. When the power storage component 22 is not fully charged, the input controller 18 may divert power, including voltage and current, from the computer interface or other interface through the first bus 16 to the second bus 20. Therefore, the power storage component 22 may receive the necessary voltage and current to fully charge and store power from the second bus 20. When the power storage component 22 is fully charged, the input controller 18 may stop diverting power, including voltage and current. In one embodiment, such as when the power storage component 22 is fully charged, the input controller may directly connect the first bus 16 to the third bus 24 and may allow resources, such as power, voltage, current, and/or data to pass therethrough.

The output controller 26 may communicate with a device connected to the power management apparatus 10 on the first end 12. Specifically, the output controller 26 may determine the amount of resources (such as power, voltage, current, and/or data) that the device needs at a particular point in time. In one embodiment, such as when the device requires only minimal resources, the output controller 26 may connect the third bus 24 to the fifth bus 30 and allow the resources to flow therethrough. In one embodiment, such as when the device requires only minimal resources, the input controller may directly connect the first bus 16 to the third bus 24 and the output controller may directly connect the third bus 24 to the fifth bus 30 to allow resources to flow directly from the second end 14 to the first end 12. Of course, FIG. 1 is shown and described as an example only, and the power management apparatus 10 may alternatively or conjunctively accommodate resource flow in a direction opposite of that described.

Computer interfaces, such as USB, Thunderbolt, or the like are limited in the amount of resources available. Often devices made to be powered by such interfaces cannot be fully powered. In another embodiment of the present invention, when the device requires more resources than currently available from the computer interface or other interface providing resources, the output controller 26 may combine resources from the power storage component 22 and the interface, which may come through the third bus 24, the input controller 18, and the first bus 16.

In an alternative embodiment of the present invention, the power storage component 22 on its own may be capable of providing the maximum amount of resources the device requires. In this embodiment, when the device requires more resources than currently available from the computer interface or other interface providing resources, the output controller 26 may directly connect the fourth bus 28 to the fifth bus 30, allowing resources such as power, voltage, current, and/or data to flow to the device directly from the power storage component 22.

Accordingly, in a preferred embodiment of the present invention, the power management apparatus 10 may be incorporated into a device, such that the power storage component 22, the output controller 26, and input controller 18 may be specifically tailored to accommodate the particular device's resource loads and requirements. Alternatively, the power management apparatus 10 may be an external universal apparatus that is adaptable to a plurality of differing devices with a plurality of differing resource requirements.

Optionally, the power management apparatus 10 may comprise a management and/or reporting component that may collect, record, and/or report information regarding a device's particular resource needs including peak, maximum, minimum, and normal operating resource needs. Additionally, the management and/or reporting component may collect, record, and/or report information regarding the amount of resources available from the power storage component 22, including whether it is fully charged or not.

In another embodiment, the power management apparatus 10 may communicate with the device it is providing resources for in order to manage power usage characteristics and best utilize the available power in relation to the device's resource requirements. The power management apparatus 10 may be capable of managing resource conservation, throttling, consistency, and other processes known to those skilled in the art to insure the best balance of operational performance and utilization with available resources.

The power storage component 22 may remain charged with the power management apparatus 10 is disconnected from a device or an interface. Alternatively, the power storage component 22 may slowly and safely discharge over time when disconnected. In another alternate embodiment, the power component 22 may safely immediately discharge when disconnected from a device or an interface.

It should be noted that various changes and modifications to the presently preferred embodiments described herein will be apparent to those skilled in the art. Such changes and modifications may be made without departing from the spirit and scope of the present invention and without diminishing its attendant advantages. Further, references throughout the specification to “the invention” are nonlimiting, and it should be noted that claim limitations presented herein are not meant to describe the invention as a whole. Moreover, the invention illustratively disclosed herein suitably may be practiced in the absence of any element which is not specifically disclosed herein.

I claim:

1. A power management apparatus comprising:
an interface input for connecting the power management apparatus to a computer interface;
a power storage component; and
a controller that manages power from the interface input and the power storage component.

2. A power management system comprising:
a peripheral device; and
a power management apparatus disposed within the peripheral device, wherein the power management apparatus comprises an interface input for connecting the power management apparatus to a computer interface, a power storage component, and a controller that manages power from the interface input and the power storage component.

3. A power management method comprising the steps of:
providing a power management apparatus comprising an interface input for connecting the power management apparatus to a computer interface, a power storage component, and a controller that manages power from the interface input and the power storage component
diverting power from an interface input having a first power level to a power storage component, directing power from the interface input to a controller, drawing power from the power storage component to the controller, and creating a second power level higher than the first power level from the controller.
